(19) United States
(12) Patent Application Publication
(10) Pub. No.: US 2024/0257259 A1
(43) Pub. Date: Aug. 1, 2024

(54) SYSTEM AND METHOD FOR SCORE GENERATION

(71) Applicant: Allstate Insurance Company, Northbrook, IL (US)

(72) Inventors: Daniel Brian Mohnen, Grayslake, IL (US); Kevin Patrick Rice, Libertyville, IL (US); Edgar Cortez, Northbrook, IL (US); Cory Luitjohan, Forest Park, IL (US); Laura Fischer-Klein, Buffalo Grove, IL (US)

(21) Appl. No.: 18/101,755

(22) Filed: Jan. 26, 2023

(51) Int. Cl. G06Q 40/08

(52) U.S. Cl. CPC G06Q 40/08

(57) ABSTRACT

Aspects of the present disclosure generally relate to systems and methods for trip data processing, and more specifically, for on-demand generation of a user score from trip data. One example method for user score generation generally includes receiving input data from one or more sensors indicating driving characteristics during one or more trips by a user, extracting, via a feature extraction system, one or more features associated with each trip of the one or more trips upon receive input data for the trip, and storing the one or more features in a features database. The method may also include retrieving, from the features database, the one or more features in response a request for generation of a user score, and generating the user score based on the one or more features retrieved from the features database.

### TECHNICAL FIELD

Aspects of the present disclosure generally relate to systems and methods for trip data processing, and more specifically, for on-demand generation of a user score from trip data.

### BACKGROUND

Telematics data from vehicles may be processed in a variety of ways to gain an understanding of the operation of the vehicles. Acceleration data, speed data, braking data, time stamps, heading data, and the like obtained from a device associated with an operated vehicle may be processed to determine aspects of the vehicle operation. For example, acceleration or speed data may be used to determine how safe a driver operates the vehicle. The telematics data may be obtained from a built-in sensing device of a vehicle, or from other devices such as a mobile device of a user.

### SUMMARY

In some aspects, the present disclosure provides an apparatus for user score generation. The apparatus generally includes: a features database; a feature extraction system configured to: receive input data indicating driving characteristics during multiple trips by a user, the input data being based on sensor data from one or more sensors; extract one or more features associated with each trip of the multiple trips upon receiving input data for the trip; and store the one or more features in the features database; a score processing system coupled to the feature extraction system and configured to: retrieve, from the features database, the one or more features in response to a request for generation of a user score; and generate the user score based on the one or more features retrieved from the features database.

In some aspects, the present disclosure provides a method for user score generation. The method generally includes: receiving, at a feature extraction system, input data indicating driving characteristics during multiple trips by a user, the input data being based on sensor data from one or more sensors; extracting, via the feature extraction system, one or more features associated with each trip of the multiple trips upon receiving input data for the trip; storing the one or more features in a features database; retrieving, from the features database and via a score processing system coupled to the feature extraction system, the one or more features in response to a request for generation of a user score; and generating, via the score processing system, the user score based on the one or more features retrieved from the features database.

In some aspects, the present disclosure provides a non-transitory computer-readable medium having instructions stored thereon, which when executed by one or more processors, causes the one or more processors to: receive input data indicating driving characteristics during multiple trips by a user, the input data being based on sensor data from one or more sensors; extract, via a feature extraction system, one or more features associated with each trip of the multiple trips upon receiving input data for the trip; store the one or more features in a features database; retrieve, from the features database, the one or more features in response to a request for generation of a user score; and generate the user score based on the one or more features retrieved from the features database.

Aspects of the present disclosure are directed towards a method for user score generation. The method generally includes receiving input data indicating driving characteristics during multiple trips by a user, the input data being based on sensor data from one or more sensors, extracting, via a feature extraction system, one or more features associated with each trip of the multiple trips upon receive input data for the trip, and storing the one or more features in a features database. The method may also include retrieving, from the features database, the one or more features in response a request for generation of a user score, and generating the user score based on the one or more features retrieved from the features database.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an operating environment in accordance with at least one implementation.

FIG. 2 illustrates an example computing device, in accordance with certain aspects of the present disclosure.

FIG. 3 illustrates an example score generation system facilitating on-demand scoring, in accordance with certain aspects of the present disclosure.

FIG. 4 illustrates an example score generation system implemented with featurization, aggregation, and scoring subsystems, in accordance with certain aspects of the present disclosure.

FIG. 5 illustrates an example score generation system implemented with a features database and trip status database, in accordance with certain aspects of the present disclosure.

FIG. 6 is a flow diagram illustrating example operations for user score generation, in accordance with certain aspects of the present disclosure.

It will be apparent to one skilled in the art after review of the entirety disclosed that the steps illustrated in the figures listed above may be performed in other than the recited order, and that one or more steps illustrated in these figures may be optional.

### DETAILED DESCRIPTION

Certain aspects of the present disclosure are directed to methods and systems for calculating driver scores in an efficient manner. Sensor data (e.g., from vehicle telematics or other sensor devices) may be received and analyzed to derive certain features associated with a user's driving behavior. As one example features, the sensor data may analyze breaking sensor data to identify hard-breaking events or features. These features may then be used to calculate a score for the user. Certain aspects of the present disclosure are directed towards techniques for increasing the efficiency associated with score calculation so that scores can be calculated quickly and on demand. For example, some aspects provide a feature extraction system that manages trip feature collections as trips are ingested in stream. Once trips are featurized (e.g., sensor data associated with a driving trip is analyzed and associated features are derived), the features are stored in a features database. For instance, the features for each of the trips may be kept in storage for a rolling period (e.g., 2-year period). When a score is requested for a user, a microservice may be called to aggregate the features (e.g., in real time) and pass those features to an aggregate scoring service where a driving score is calculated.

The techniques described herein reduce computation footprint and cost. Conventionally, to derive features and generate a user score, a large amount of driving behavior data may be received and collected. Managing driving behavior records at a scale of millions of connections involves large distributed architectures. This results in a large computing footprint to maintain and run a score generation system. The aspects of the present disclosure save computation time since a score for each of multiple users are calculated upon request. In other words, in a conventional system, a score for all users in the system may be calculated frequently (e.g., on a daily basis) because any particular user score may be requested at any time. As a result, computation resources may be used to calculate user scores that may not actually be requested, resulting in a waste of computation resources. Aspects of the present disclosure provide a system that performs feature extraction in stream and stores the features in a database. In this manner, a score may be calculated for a specific user as needed on demand, saving computation resources. In other words, given the availability of the extracted features in the database, only the scores that are requested may be calculated on-demand, reducing the computing footprint to maintain and run the score generation system.

Some aspects of the present disclosure provide an improvement over simply applying a model to large quantities of data each time a score is to be generated for a user. As described, the score generation system persists features to be aggregated to calculate a user score. This is performed to reduce the costs of maintaining and deriving scores which may be infrequently accessed. The system also provides an on-demand scoring service which when called, will extract aggregate features from the database and pass those aggregates to the scoring system. The on-demand scoring technique described herein may facilitate a score to be calculated quickly (e.g., within 250 ms). Featurization may be implemented using different feature extraction models. Features associated with multiple feature extraction models may be derived and stored in the database, allowing a score to be generated on-demand for any specific model as requested.

These and various other arrangements will be described more fully herein. As will be appreciated by one of skill in the art upon reading the following disclosure, various aspects described herein can be a method, a computer system, or a computer program product. Accordingly, those aspects can take the form of an entirely hardware implementation, an entirely software implementation, or at least one implementation combining software and hardware aspects. Furthermore, such aspects can take the form of a computer program product stored by one or more computer-readable storage media having computer-readable program code, or instructions, included in or on the storage media. Any suitable computer-readable storage media can be utilized, including hard disks, CD-ROMs, non-volatile memory, solid state storage, optical storage devices, magnetic storage devices, and/or any combination thereof. In addition, various signals representing data or events as described herein can be transferred between a source and a destination in the form of electromagnetic waves traveling through signal-conducting media such as metal wires, optical fibers, and/or wireless transmission media (e.g., air and/or space).

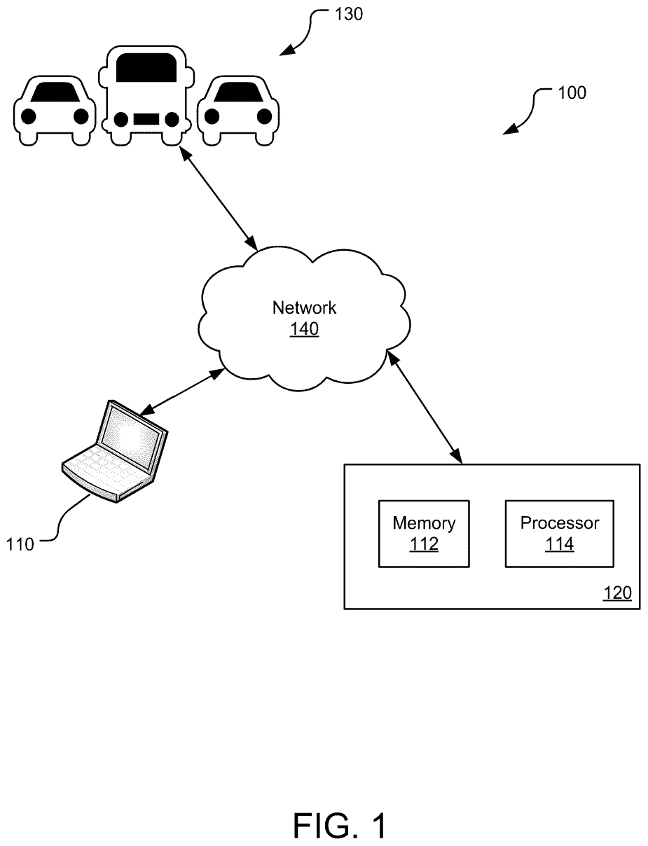

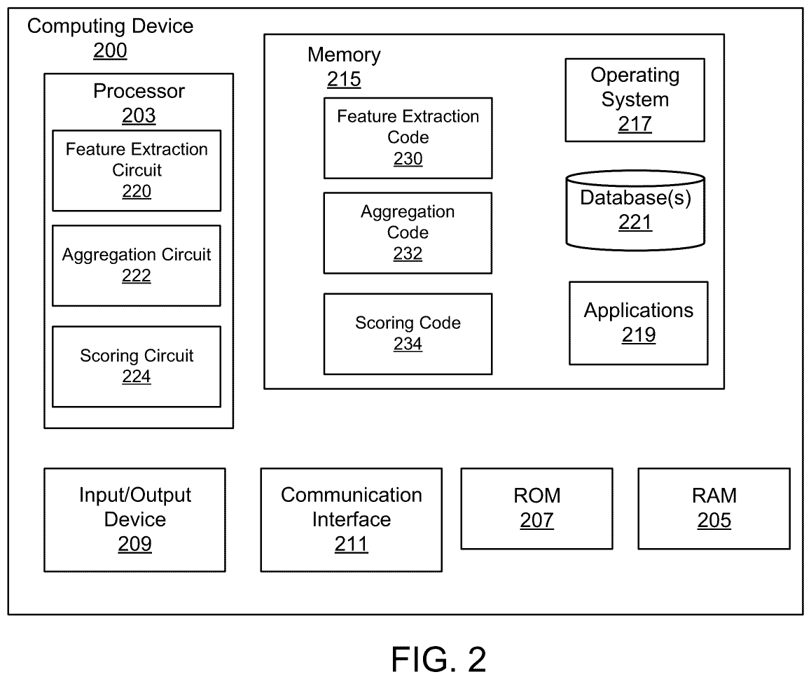

FIG. 1 illustrates an operating environment 100 in accordance with at least one implementation. The operating environment 100 includes at least one client device 110, at least one classification server system 120, and/or at least one vehicle 130 in communication via a network 140. The network 140 can include a local area network (LAN), a wide area network (WAN), a wireless telecommunications network, and/or any other communication network or combination thereof. Any of the devices and systems described herein can be implemented, in whole or in part, using one or more computing devices described with respect to FIG. 2. For example, classification server system 120 may include one or more processors 114 and a non-transitory memory 112. Client devices 110 and/or the at least one vehicle 130 may include similar components, in addition to other components described below.

Vehicle 130 can be, for example, an automobile, motorcycle, scooter, bus, recreational vehicle, boat, or other vehicle for which sensor or crash data can be collected and analyzed. A telematics device within the vehicle 130 can be used to collect and/or receive sensor data and/or to receive sensor data from the vehicle 130. A telematics device can be, for example, mobile phones, personal digital assistants (PDAs), tablet computers, laptop computers, smartwatches, and other devices that can be carried by drivers or passengers inside or outside of the vehicle 130. The telematics device can also be integrated into the vehicle 130 and/or connected to a data bus within the vehicle 130 via a diagnostic connector, such as an OBD-II connector. The telematics device can receive a variety of data, such as acceleration, velocity, location, vehicle operation data such as braking, turning, swerving, and the like from sensors located within the telematics device and/or vehicle. For example, a telematics device having a Global Positioning System (GPS) receiver can determine vehicle location, speed, direction, and other basic driving data without needing to communicate with vehicle sensors or external vehicle systems. However, it should be noted that any of a variety of other location determination techniques, such as location determined based on wireless networks to which the mobile device is connected, such as Wi-Fi networks, cellular networks, and the like, can also be used. The sensors of the telematics device, such as a GPS and/or a compass, can sense the speed and/or direction at which the telematics device (and accordingly vehicle 130) is traveling. An accelerometer of the telematics device can sense the acceleration of the mobile device. A gyroscope can be used to determine the orientation of the mobile device. In some aspects, orientation can be detected, for example, at a rate of 90 Hz. The gyroscope can also be used to measure the speed of rotation of the telematics device. A magnetometer can be used to measure the strength and direction of the magnetic field relative to the telematics device. The data collected by the telematics device can be stored and/or analyzed within the telematics device. Additionally or alternatively, the telematics device can transmit, via a wired or wireless transmission network, the data to one or more computing devices for storage and/or analysis. In a variety of implementations, the telematics device transmits data indicating a route the vehicle or driver has traveled, including multiple points along the route of travel. As explained in more detail below, the location points of the route may include a latitude value, a longitude value, and a sequence value. Other location services and systems may provide alternative or additional information to locate the vehicle or driver along a route or “trip”.

Vehicle 130 can further include a short-range communication system. The short-range communication systems can be a vehicle-based data transmission systems configured to transmit vehicle operational data to other nearby vehicles, and to receive vehicle operational data from other nearby vehicles. In some examples, communication system can use the dedicated short-range communications (DSRC) protocols and standards to perform wireless communications between vehicles. In the United States, 75 MHz in the 5.850-5.925 GHz band have been allocated for DSRC systems and applications, and various other DSRC allocations have been defined in other countries and jurisdictions. However, short-range communication system need not use DSRC, and can be implemented using other short-range wireless protocols in other examples, such as WLAN communication protocols (e.g., IEEE 802.11), Bluetooth (e.g., IEEE 802.15.1), or one or more of the Communication Access for Land Mobiles (CALM) wireless communication protocols and air interfaces. Vehicle-to-vehicle (V2V) transmissions between the short-range communication system can be sent via DSRC, Bluetooth, satellite, GSM infrared, IEEE 802.11, WiMAX, RFID, and/or any suitable wireless communication media, standards, and protocols. In certain systems, the short-range communication system can include specialized hardware installed in vehicle 130 (e.g., transceivers, antennas, etc.), while in other examples the short-range communication system can be implemented using existing vehicle hardware components (e.g., radio and satellite equipment, navigation computers) or can be implemented by software running on a telematics device within (or near) the vehicle 130. The range of V2V communications can depend on the wireless communication standards and protocols used, the transmission/reception hardware (e.g., transceivers, power sources, antennas), and other factors. Short-range V2V communications can range from just a few feet to many miles, and different types of driving behaviors, vehicle operational parameters, and the like, can be determined depending on the range of the V2V communications.

V2V communications also can include vehicle-to-infrastructure (V2I) communications, such as transmissions to or from vehicles to or from non-vehicle receiving devices, such as infrastructure. Infrastructure can include one or more of toll booths, railroad crossings, parking garages, road segments, parking lots, buildings or other structures, and/or road-side traffic monitoring devices which can include one or more sensors for detecting environmental conditions (e.g., weather, lighting, etc.) as well as parking availability. Certain V2V communication systems can periodically broadcast data from vehicle 130 to any other vehicle or other infrastructure device capable of receiving the communication within the range of the vehicle's transmission capabilities. For example, vehicle 130 can periodically broadcast (e.g., every 0.1 second, every 0.5 seconds, every second, every 5 seconds, dynamically, etc.) certain vehicle operation data via its short-range communication system, regardless of whether or not any other vehicles or reception devices are in range. In other examples, a short-range vehicle communication system can first detect nearby vehicles and receiving devices and can initialize communication with each by performing a handshaking transaction before beginning to transmit its vehicle operation data to the other vehicles and/or devices. Broadcasts from infrastructure can also have varying ranges and, in some examples, infrastructure can broadcast to an intermediate station which can then relay the information to one or more computing devices.

The types of vehicle operational data, vehicle driving data, breakdown issue data, or the like, transmitted to or from vehicle 130 and/or infrastructure can depend on the protocols and standards used for the V2V or V2I communication, the range of communications, and other factors. In certain examples, vehicle 130 can periodically broadcast corresponding sets of similar vehicle driving data, such as the location (which can include an absolute location in GPS coordinates or other coordinate systems, and/or a relative location with respect to another vehicle or a fixed point), speed, and direction of travel. In certain examples, the nodes in a V2V (or V2I) communication system (e.g., vehicles and other reception devices) can use internal clocks with synchronized time signals and can send transmission times within V2V (or V2I) communications so that the receiver can calculate its distance from the transmitting node based on the difference between the transmission time and the reception time. The state or usage of the vehicle's controls and instruments can also be transmitted, for example, whether the vehicle 130 is accelerating, braking, turning, and by how much, and/or which of the vehicle's instruments are currently activated by the driver (e.g., head lights, turn signals, hazard lights, cruise control, 4-wheel drive, traction control, etc.). Vehicle warnings such as a detection by the vehicle's internal systems that the vehicle is skidding, that an impact has occurred, or that the vehicle's airbags have been deployed, that a vehicle has stopped unexpectedly, also can be transmitted in V2V (or V2I) communications.

In various other examples, any data collected by any vehicle sensors potentially can be transmitted via V2V or V2I communication to other nearby vehicles or infrastructure devices receiving V2V or V2I communications from a short-range communication system. Further, additional vehicle driving data not from the vehicle's sensors (e.g., vehicle make/model/year information, driver insurance information, driving route information, vehicle maintenance information, driver scores, etc.) can be collected and transmitted using V2V or V2I communications to nearby vehicles and other receiving devices using the short-range communication system. Collected data may be from on-board or mobile telematics data, and in some cases, may be uploaded using any suitable wireless communication network. In some implementations, the collected data may be obtained from any suitable sensors that may be part of, or separate from the vehicle. For example, data may be collected from cameras or in-road sensors that may be within the vicinity of the vehicle.

The data transferred to and from various devices in operating environment 100 can include secure and sensitive data. Therefore, it can be desirable to protect transmissions of such data using secure network protocols and encryption and to protect the integrity of the data when stored on the various computing devices within the software deployment system. For example, a file-based integration scheme or a service-based integration scheme can be utilized for transmitting data between the various computing devices. Data can be transmitted using various network communication protocols. Secure data transmission protocols and/or encryption can be used in file transfers to protect the integrity of the data, for example, File Transfer Protocol (FTP), Secure File Transfer Protocol (SFTP), and/or Pretty Good Privacy (PGP) encryption. In many implementations, one or more web services can be implemented within the various computing devices. Web services can be accessed by authorized external devices and users to support input, extraction, and manipulation of data between the various computing devices in the operating environment 100. Web services built to support a personalized display system can be cross-domain and/or cross-platform and can be built for enterprise use. Such web services can be developed in accordance with various web service standards, such as the Web Service Interoperability (WS-1) guidelines. Data can be transmitted using the Secure Sockets Layer (SSL) or Transport Layer Security (TLS) protocol to provide secure connections between the computing devices.

It will be appreciated that the network connections shown are illustrative and other means of establishing a communications link between the computers can be used. The existence of any of various network protocols such as TCP/IP, Ethernet, FTP, secure FTP (SFTP), HTTP and the like, and of various wireless communication technologies such as 5G, LTE, GSM, CDMA, WiFi, and WiMAX, is presumed, and the various computing devices described herein can be configured to communicate using any of these network protocols or technologies.

FIG. 2 illustrates an example computing device 200, in accordance with certain aspects of the present disclosure. The computing device 200 can include a processor 203 for controlling overall operation of the computing device 200 and its associated components, including RAM 205, ROM 207, input/output device 209, communication interface 211, memory 215, solid state/magnetic storage, and/or network attached storage devices. A data bus can interconnect processor(s) 203, RAM 205, ROM 207, memory 215, I/O device 209, and/or communication interface 211.

Input/output (I/O) device 209 can include a microphone, keypad, touch screen, optical sensor, and/or stylus through which a user of the computing device 200 can provide input and can also include one or more of a speaker for providing audio output and a video display device for providing textual, audiovisual, and/or graphical output. Software can be stored within memory 215 to provide instructions to processor 203 allowing computing device 200 to perform various actions. For example, memory 215 can store software used by the computing device 200, such as an operating system 217, application programs 219, and/or an associated internal database 221. The various hardware memory units in memory 215 can include volatile and nonvolatile, removable, and non-removable media implemented in any method or technology for storage of information such as computer-readable instructions, data structures, program modules or other data. Memory and storage may be used interchangeably herein as generally referring to any component for storing data. Memory 215 can include one or more physical persistent memory devices and/or one or more non-persistent memory devices. Memory 215 can include, but is not limited to, random access memory (RAM) 205, read only memory (ROM) 207, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 203.

Communication interface 211 can include one or more transceivers, digital signal processors, and/or additional circuitry and software for communicating via any network, wired or wireless, using any protocol as described herein. Processor 203 can include a single central processing unit (CPU), which can be a single-core or multi-core processor (e.g., dual-core, quad-core, etc.), or can include multiple CPUs. The processor 203 may be implemented using virtual computing. Processor(s) 203 and associated components can allow the computing device 200 to execute a series of computer-readable instructions to perform some or all of the processes described herein. Although not shown in FIG. 2, various elements within memory 215 or other components in computing device 200, can include one or more caches, for example, CPU caches used by the processor 203, page caches used by the operating system 217, disk caches of a hard drive, and/or database caches used to cache content from database 221. For implementations including a CPU cache, the CPU cache can be used by one or more processors 203 to reduce memory latency and access time. A processor 203 can retrieve data from or write data to the CPU cache rather than reading/writing to memory 215, which can improve the speed of these operations. In some examples, a database cache can be created in which certain data from a database 221 is cached in a separate smaller database in a memory separate from the database, such as in RAM 205 or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

In some aspects, the processor 203 may include circuit 220 for feature extraction, circuit 222 for aggregation, and circuit 224 for scoring. The memory 215 may store code which, when executed by the processor 203, performs the operations described herein. For example, the memory 215 may include code 230 for feature extraction, code 232 for aggregation, and code 234 for scoring. Although various components of computing device 200 are described separately, functionality of the various components can be combined and/or performed by a single component and/or multiple computing devices in communication. The computing device 200 may be one or more virtual machines that run on a physical server.

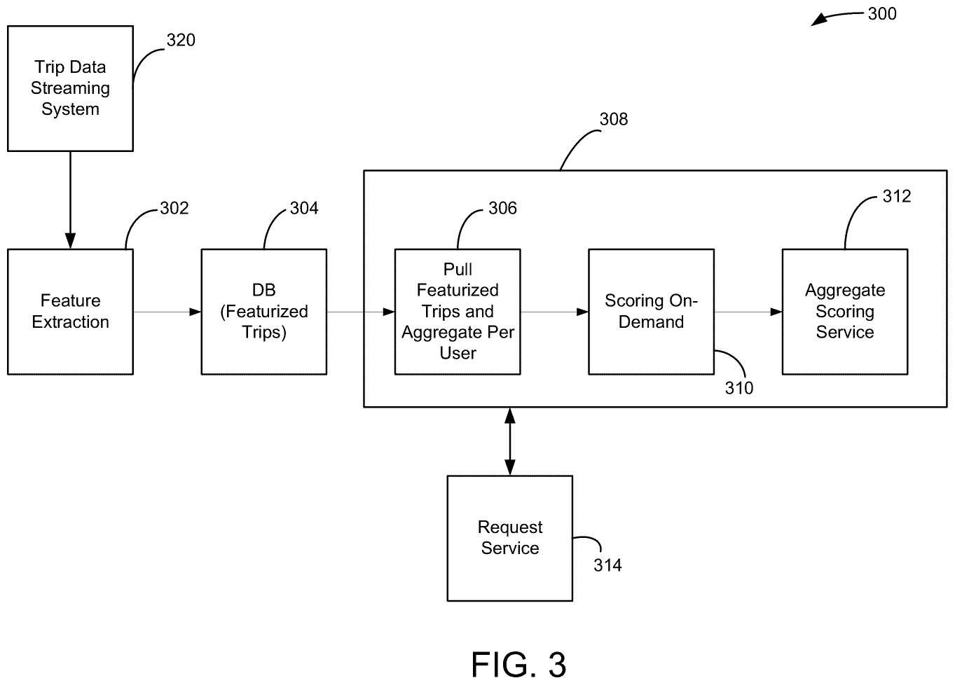

FIG. 3 illustrates a score generation system 300 facilitating on-demand scoring, in accordance with certain aspects of the present disclosure. As shown, score generation system 300 may include a trip data streaming system 320 and features extraction system 302 (e.g., corresponding to circuit 220 for feature extraction). Trip data streaming system 320 may be communicably coupled to one or more sensors detecting driving trip data and streams the data to feature extraction system 302. The feature extraction system 302 receives the trip data (e.g., sensor data associated with one or more trips) and extracts various features associated with each trip. The extracted features for each trip (e.g., also referred to herein as featurized trips) may be stored in a features database 304.

The score generation system 300 may also include a score processing system 308. The score processing system 308 may include an aggregation system 306 (e.g., corresponding to circuit 222 for aggregation) that retrieves and aggregates features per user. For instance, based on a particular scoring configuration (e.g., also referred to herein as a model), the aggregation system 306 may retrieve trip features from features database 304 that may be used for generating a user score for that scoring configuration. As an example, the particular scoring configuration may require scoring to be performed on all featurized trips during a certain time period and taking into account certain feature types. Aggregation system 306 retrieves the features for the time period and having the feature types, and generates an aggregate feature file including those features. The file may be provided to a scoring system 310 of the score processing system 308.

Scoring system 310 (e.g., corresponding to circuit 224 for scoring) may generate a score based on the aggregated features. For example, a certain number of points (positive or negative) may be assigned to each feature, which may be summed to generate the final user score. In some cases, the scoring may be performed based on a scoring configuration. For example, different scoring configurations may correlate to different weights associated with features. As one example, a particular scoring configuration may provide greater weight to a breaking feature (e.g., hard breaking) as opposed to a high speed feature. In some cases, score processing system 308 may also include an aggregate scoring service 312. Aggregate scoring service 312 may receive user scores of various users and generate an aggregate user score.

As described herein, score processing system 308 may generate a score on-demand based on stored features. Score generation system 300 may include a request service 314 which may provide a score calculation request to score processing system 308. The request may originate from any authorized entity that wishes to know a score of a specific user. The aggregation of features and score generation described herein may be performed in response to the authorized request from the request service 314.

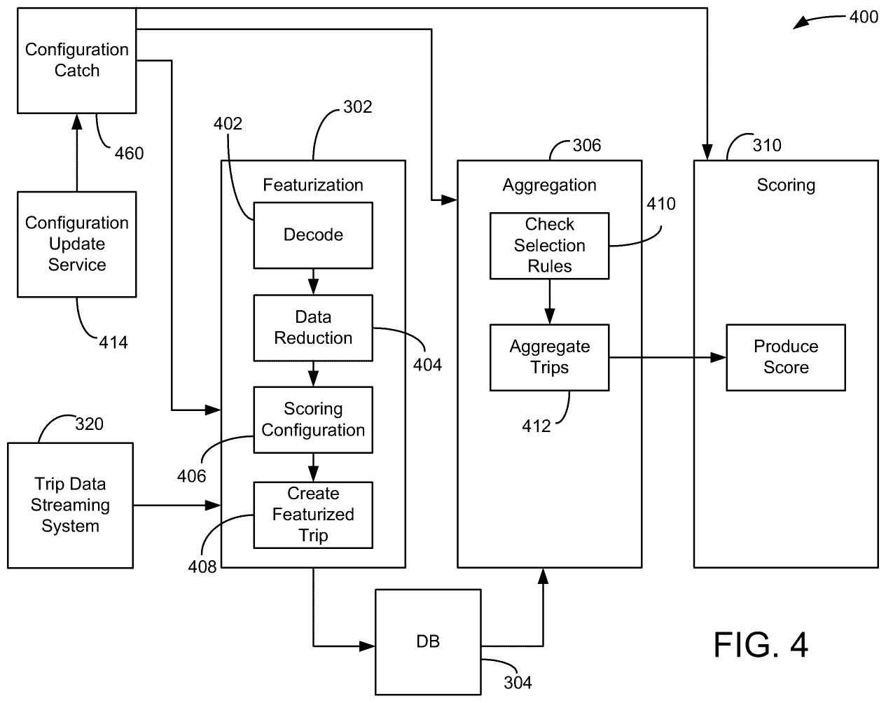

FIG. 4 illustrates an example score generation system 400, in accordance with certain aspects of the present disclosure. Score generation system 400 may correspond to score generation system 300 described with respect to FIG. 3.

As shown, score generation system 400 includes feature extraction system 302 having a decode component 402. Decode component 402 may receive trip data from trip data streaming system 320 and generate data that can be processed for featurization. For instance, information corresponding to various codes that are part of the trip data may be identified (e.g., a code in the trip data may indicate a breaking event). The decoded trip data may be sent to a data reduction component 404. The data reduction component 404 may identify parts of the trip data that are not used for feature extraction and generates size-reduced trip data without such trip data parts. The size-reduced trip data may be provided to a scoring configuration component 406. Scoring configuration component 406 may select a portion of the trip data based on a scoring configuration (e.g., which may be specific to an organization associated with the user being scored). For instance, depending on the organization associated with the user, some portions of the trip data may not be used for producing the user score. The trip data from the output of the scoring configuration component 406 is then provided to a featurization component 408, which generates the features and saves the features to features database 304.

The featurization techniques described may be performed as trips for various users are received (e.g., as the trips are streamed in). The features may be extracted for each of multiple users and for each of multiple scoring configurations (e.g., models). In this manner, scores can be generated on demand based on previously extracted features for any user and for any scoring configuration.

Upon request, features for a specific user may be retrieved and aggregated via aggregation system 306, as described. Aggregation system 306 may include selection rule component 410. Selection rule component 410 may determine whether a user score can be generated for a specific scoring configuration. For example, some specific scoring configuration may require a certain amount of trip data before a score can be generated. For instance, a scoring configuration may require 50 trips before a score can be generated. Selection rule component 410 may ensure that the proper amount of trip data is available before a user score is generated. Aggregation system 306 may also include aggregation component 412 that aggregates the features (e.g., for a specific time period per the scoring configuration) and generates a document including the aggregated features, as described herein. The document is provided to scoring system 310 for generation of the score.

In some aspects, score generation system 400 may include a configuration cache 460 including the score configurations (e.g., models), described herein. Score generation system 400 may also include a configuration update service 414 that may be used to update the scoring configurations stored in configuration cache 460.

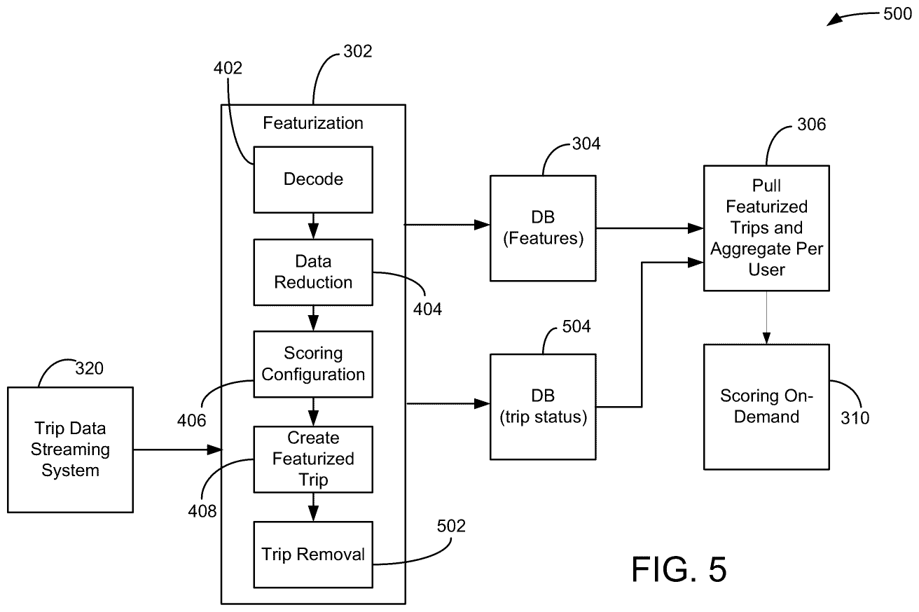

FIG. 5 illustrates an example score generation system 500, in accordance with certain aspects of the present disclosure. Score generation system 500 may correspond to score generation system 400 described with respect to FIG. 4 and score generation system 300 described with respect to FIG. 3. As shown, extraction system 302 may also include a trip removal component 502. Trip removal component 502 may identify certain trips that should be removed from consideration for user score determination. For example, trip removal component 502 may identify some trips where the user is not the driver (e.g., the user is a passenger in a vehicle or riding a bus car share ride, or riding an electric bicycle). In this case, trip removal component 502 may remove features associated with such trips from consideration when the score is determined.

As shown, score generation system 500 may be implemented with features database 304 described with respect to FIGS. 3 and 4, but may also include a trip status database 504. Trip status database 504 may store the status of each trip including a historical record of when a status of a trip was updated. For example, trip status database 504 may identify that a specific trip was a bus trip. Trip status database 504 may also indicate when the trip was changed from a regular trip (e.g., where the user was assumed to be the driver) to a bus trip where the user is a passenger. The status of the trip as indicated in trip status database 504 may be used by aggregation system 306 to determine which features to aggregate for score determination. In other words, as described herein, a trip where the user was a passenger may not be used to derive the user score for the user. The historical record of trip status allows for identifying what trips were considered in previously calculated user scores.

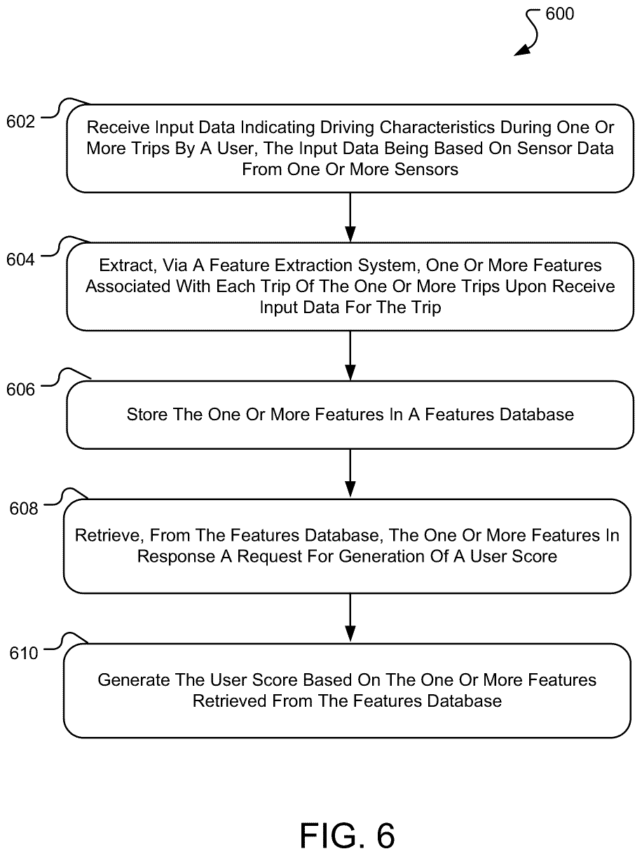

FIG. 6 is a flow diagram illustrating example operations 600 for user score generation, in accordance with certain aspects of the present disclosure. The operations 600 may be performed for example, by a score generation system, such as the score generation system 300.

At block 602, the score generation system may receive, at a feature extraction system (e.g., feature extraction system 302), input data indicating driving characteristics during one or more trips (e.g., multiple trips) by a user, the input data being based on sensor data from one or more sensors. At block 604, the score generation system extracts, via the feature extraction system, one or more features associated with each trip of the one or more trips upon receiving input data for the trip. In some cases, the score generation system determines the one or more features to be extracted based on a configuration retrieved from a configuration database (e.g., configuration cache 460).

At block 606, the score generation system stores the one or more features in a features database (e.g., for a unique trip and for a unique user). For example, the one or more features are extracted and stored in the features database as the input data for the trip is received. The one or more features for a first trip of the multiple trips may be extracted and stored in the features database prior to the one or more features for a second trip of the multiple trips being extracted and stored in the features database.

At block 608, the score generation system retrieves, from the features database and via a score processing system (e.g., score processing system 308) coupled to the feature extraction system, the one or more features in response to a request for generation of a user score. Retrieving the one or more features may include aggregating (e.g., via aggregation system 306) features associated with the multiple trips by the user based on a configuration retrieved from a configuration database (e.g., configuration cache 460). For example, the configuration may indicate the trips to be selected for aggregation (e.g., 180 days of trips for one model or configuration or 365 for another model or configuration).

The score generation system may generate (e.g., via aggregation system 306) a document including the aggregated features, wherein the user score is generated based on the document.

At block 610, the score generation system generates, via the score processing system, the user score based on the one or more features retrieved from the features database. In some aspects, the user score is generated based on a configuration (e.g., stored in configuration cache 460) indicating weights associated with each of the one or more features. In some aspects, the score generation system may determine whether a user score generation criteria has been met before generating the user score (e.g., as described with respect selection rule component 410 of FIG. 4). The user score generation criteria may include whether a minimum quantity of trips by the user are available for generating the user score.

Implementations of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an implementation in the present disclosure can be references to the same implementation or any implementation; and, such references mean at least one of the implementations.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Example Clauses:

Clause 1. An apparatus for user score generation, comprising: a features database; a feature extraction system configured to: receive input data from one or more sensors indicating driving characteristics during one or more trips by a user; extract one or more features associated with each trip of the one or more trips upon receiving input data for the trip; and store the one or more features in the features database; a score processing system coupled to the feature extraction system and configured to: retrieve, from the features database, the one or more features in response to a request for generation of a user score; and generate the user score based on the one or more features retrieved from the features database.

Clause 2. The apparatus of clause 1, wherein the one or more features are extracted and stored in the features database as the input data for the trip is received.

Clause 3. The apparatus of any one of clauses 1-2, wherein the one or more trips include multiple trips, and wherein the one or more features for a first trip of the multiple trips are extracted and stored in the features database prior to the one or more features for a second trip of the multiple trips being extracted and stored in the features database.

Clause 4. The apparatus of any one of clauses 1-3, wherein the feature extraction system is further configured to determine the one or more features to be extracted based on a configuration retrieved from a configuration database.

Clause 5. The apparatus of any one of clauses 1-4, wherein the user score is generated based on a configuration indicating weights associated with each of the one or more features.

Clause 6. The apparatus of any one of clauses 1-6, wherein the one or more trips include multiple trips, and wherein, to retrieve the one or more features, the score processing system is configured to aggregate features associated with the multiple trips by the user based on a configuration retrieved from a configuration database.

Clause 7. The apparatus of clause 6, wherein the score processing system is configured to generate a document including the aggregated features, wherein the user score is generated based on the document.

Clause 8. The apparatus of any one of clauses 1-7, wherein the score processing system is configured to determine whether a user score generation criteria has been met before generating the user score.

Clause 9. The apparatus of clause 8, wherein the user score generation criteria includes whether a minimum quantity of trips by the user are available for generating the user score.

Clause 10. A method for user score generation, comprising: receiving, at a feature extraction system, input data from one or more sensors indicating driving characteristics during one or more trips by a user; extracting, via the feature extraction system, one or more features associated with each trip of the one or more trips upon receiving input data for the trip; storing the one or more features in a features database; retrieving, from the features database and via a score processing system coupled to the feature extraction system, the one or more features in response to a request for generation of a user score; and generating, via the score processing system, the user score based on the one or more features retrieved from the features database.

Clause 11. The method of clause 10, wherein the one or more features are extracted and stored in the features database as the input data for the trip is received.

Clause 12. The method of any one of clauses 10-11, wherein the one or more trips include multiple trips, and wherein the one or more features for a first trip of the multiple trips are extracted and stored in the features database prior to the one or more features for a second trip of the multiple trips being extracted and stored in the features database.

Clause 13. The method of any one of clauses 10-12, further comprising determining the one or more features to be extracted based on a configuration retrieved from a configuration database.

Clause 14. The method of any one of clauses 10-13, wherein the user score is generated based on a configuration indicating weights associated with each of the one or more features.

Clause 15. The method of any one of clauses 10-14, wherein the one or more trips include multiple trips, and wherein retrieving the one or more features includes aggregating features associated with the multiple trips by the user based on a configuration retrieved from a configuration database.

Clause 16. The method of clause 15, further comprising generating a document including the aggregated features, wherein the user score is generated based on the document.

Clause 17. The method of any one of clauses 10-16, further comprising determining whether a user score generation criteria has been met before generating the user score.

Clause 18. The method of clause 17, wherein the user score generation criteria includes whether a minimum quantity of trips by the user are available for generating the user score.

Clause 19. A non-transitory computer-readable medium having instructions stored thereon, which when executed by one or more processors, causes the one or more processors to: receive input data indicating driving characteristics during one or more trips by a user, the input data being based on sensor data from one or more sensors; extract, via a feature extraction system, one or more features associated with each trip of the one or more trips upon receiving input data for the trip; store the one or more features in a features database; retrieve, from the features database, the one or more features in response to a request for generation of a user score; and generate the user score based on the one or more features retrieved from the features database.

Clause 20. The non-transitory computer-readable medium of clause 19, wherein the one or more features are extracted and stored in the features database as the input data for the trip is received.

We claim:

1. An apparatus for user score generation, comprising:
a features database;
a feature extraction system configured to:
receive input data indicating driving characteristics during one or more trips by a user, the input data being based on sensor data from one or more sensors;
extract one or more features associated with each trip of the one or more trips upon receiving input data for the trip; and
store the one or more features in the features database; and
a score processing system coupled to the feature extraction system and configured to:
retrieve, from the features database, the one or more features in response to a request for generation of a user score; and
generate the user score based on the one or more features retrieved from the features database.

2. The apparatus of claim 1, wherein the one or more features are extracted and stored in the features database as the input data for the trip is received.

3. The apparatus of claim 1, wherein the one or more trips include multiple trips, and wherein the one or more features for a first trip of the multiple trips are extracted and stored in the features database prior to the one or more features for a second trip of the multiple trips being extracted and stored in the features database.

4. The apparatus of claim 1, wherein the feature extraction system is further configured to determine the one or more features to be extracted based on a configuration retrieved from a configuration database.

5. The apparatus of claim 1, wherein the user score is generated based on a configuration indicating weights associated with each of the one or more features.

6. The apparatus of claim 1, wherein the one or more trips include multiple trips, and wherein, to retrieve the one or more features, the score processing system is configured to aggregate features associated with the multiple trips by the user based on a configuration retrieved from a configuration database.

7. The apparatus of claim 6, wherein the score processing system is configured to generate a document including the aggregated features, wherein the user score is generated based on the document.

8. The apparatus of claim 1, wherein the score processing system is configured to determine whether a user score generation criteria has been met before generating the user score.

9. The apparatus of claim 8, wherein the user score generation criteria includes whether a minimum quantity of trips by the user are available for generating the user score.

10. A method for user score generation, comprising:
receiving, at a feature extraction system, input data indicating driving characteristics during one or more trips by a user, the input data being based on sensor data from one or more sensors;
extracting, via the feature extraction system, one or more features associated with each trip of the one or more trips upon receiving input data for the trip;
storing the one or more features in a features database;
retrieving, from the features database and via a score processing system coupled to the feature extraction system, the one or more features in response to a request for generation of a user score; and
generating, via the score processing system, the user score based on the one or more features retrieved from the features database.

11. The method of claim 10, wherein the one or more features are extracted and stored in the features database as the input data for the trip is received.

12. The method of claim 10, wherein the one or more trips include multiple trips, and wherein the one or more features for a first trip of the multiple trips are extracted and stored in the features database prior to the one or more features for a second trip of the multiple trips being extracted and stored in the features database.

13. The method of claim 10, further comprising determining the one or more features to be extracted based on a configuration retrieved from a configuration database.

14. The method of claim 10, wherein the user score is generated based on a configuration indicating weights associated with each of the one or more features.

15. The method of claim 10, wherein the one or more trips include multiple trips, and wherein retrieving the one or more features includes aggregating features associated with the multiple trips by the user based on a configuration retrieved from a configuration database.

16. The method of claim 15, further comprising generating a document including the aggregated features, wherein the user score is generated based on the document.

17. The method of claim 10, further comprising determining whether a user score generation criteria has been met before generating the user score.

18. The method of claim 17, wherein the user score generation criteria includes whether a minimum quantity of trips by the user are available for generating the user score.

19. A non-transitory computer-readable medium having instructions stored thereon, which when executed by one or more processors, causes the one or more processors to:
receive input data indicating driving characteristics during one or more trips by a user, the input data being based on sensor data from one or more sensors;
extract, via a feature extraction system, one or more features associated with each trip of the one or more trips upon receiving input data for the trip;
store the one or more features in a features database;
retrieve, from the features database, the one or more features in response to a request for generation of a user score; and
generate the user score based on the one or more features retrieved from the features database.

20. The non-transitory computer-readable medium of claim 19, wherein the one or more features are extracted and stored in the features database as the input data for the trip is received.
